(19) United States
(12) Patent Application Publication
(10) Pub. No.: US 2003/0188473 A1
(43) Pub. Date: Oct. 9, 2003

(54) Insect extermination device

(76) Inventor: Alfred Heller, Aachen (DE)

Correspondence Address: WILLIAM COLLARD, COLLARD & ROE, P.C., 1077 NORTHERN BOULEVARD, ROSLYN, NY, 11576, US

(21) Appl. No.: 10/276,887

(22) PCT Filed: Feb. 16, 2001
(86) PCT No.: PCT/DE01/00604

(30) Foreign Application Priority Data
May 20, 2000 (DE) 200 09 135.2

(51) Int. Cl. A01M 3/02; A01M 5/02

(52) U.S. Cl. 43/137

(57) ABSTRACT

The invention relates to a simple and effective insect extermination device with which insects are killed by slowly advancing the device towards the insects and squashing them. The inventive device is preferably produced from perspex and comprises a base plate (1), a joint (2), a handle (3) and handle extension pieces (4, 5).

The invention relates to an insect extermination device.

Several agents are available for combating or exterminating insects. All of these however have certain disadvantages.

Chemical insect extermination agents function well. They are however difficult to apply, expensive and have health risks.

Electric insect extermination devices need by their very nature an electrical outlet, which is not available everywhere. They are relatively large and expensive to procure and maintain.

Static insect extermination devices like e.g. self-adhesive garlands are also known. These should be rejected for aesthetic and hygienic reasons due to the insect cadavers adhering to them after a certain time.

A relatively simple agent are the so-called fly swatters, which have a handle attached to a flexible blade full of holes. Usually they are formed completely from a colored plastic. When using this device however, the insects are usually prompted to flee already due to the draft of air that is produced. Partially, they cannot be used at all in certain cases since they are not appropriate for certain space situations (corners, high walls, ceilings). If the insects are on people, the use is also out of the question since it would be connected with painful experiences.

The invention is therefore based on the problem of specifying an insect extermination device that avoids the disadvantages known from the state of the art. It should have the highest degree of efficiency and practicability, should be easy to use and clean and be able to be manufactured economically.

This problem is solved in a surprisingly simple way with the characteristics listed in patent claim 1.

The longitudinal axis of the handle, which formed in the shape of a shaft and is arranged at the base plate, penetrates the plain of the base plate. This arrangement allows it to exert a force in the direction of the longitudinal axis of the device. Through this, it is possible not to kill the insect with the device by hitting it, but rather by advancing the device forward in a well-directed manner and squashing the insect. The insect that is to be exterminated thus is not warned of the threatening danger by an air draft created by a quick movement since the device can be slowly advanced toward the insect without an air draft arising.

The base plate selected for the device is so large that the insect cannot flee fast enough from the deadly action radius of the device, even if it still is warned by a careless movement. A slow approach to the insect is necessary and also does not result in painful injuries, even when used to kill insects that are on people.

Advantageous embodiments of the invention are subject of the subclaims.

The shaft-shaped handle can be formed at the base plate or formed with the base plate as one piece as required by production circumstances.

It is preferred that the shaft-shaped handle can be attached and detached from the base plate. Through this, the device now can be dismantled into its individual parts and thus there is room for it for example even in a travel bag or suitcase.

Moreover, the connection is still economical and easy to manufacture if the shaft-shaped handle is attached to the base plate by means of a coupling piece like a grafting or something similar.

It is furthermore especially advantageous if the coupling piece is formed as a joint that is adjustable in various angles or can be locked into place. This leads to the device also being able to be used in situations in which it would have failed before due to its rigidity. Thus it is no longer a problem to kill insects that are at a relatively high level on a vertical wall since the angle only simply has to be slightly adjusted.

Moreover, it is advantageous if the base plate has at least one corner, preferably a right-angled corner. The embodiments are especially preferred that have a base plate that is right-angled, and above all formed as a square. These embodiments have the decisive advantage that the device comes into every corner of a room.

A further preferred embodiment is present if the shaft-shaped handle is formed that can be extended. Thus it is now no longer a problem to kill insects that for example are on the high ceilings of old buildings. The handle can be extended like a telescope or can be augmented by means of extension pieces.

It is preferred that the device be formed out of a material that can be washed off or is washable or even can be cleaned in a dishwasher so that the device can be maintained in a condition that is at all times optically attractive and hygienically immaculate.

An especially preferred embodiment is present when the insect extermination device consists of a transparent or translucent material, especially of transparent plastic like polyethylene (PE), polyethylene methacrylate (PMMA, Lucite, plexiglass), polycarbonate (PC) or similar things. Through this, the success of the use of the device is again considerably increased. On the one hand, the insects are no longer warned since they no longer perceive the danger (due to a lack of optical stimuli, since they are invisible). On the other hand, the locating of the insect by the particular person is now much easier since a constant visual contact is guaranteed due to the transparency of the material.

Finally, the embodiment provides for several interchangeable base plates of various sizes and/or forms and/or materials. Through this, the optimized base plates can be used alternatively for various application purposes.

The invention is explained in more detail below by means of a preferred embodiment and with reference to the attached figures, which show the following:

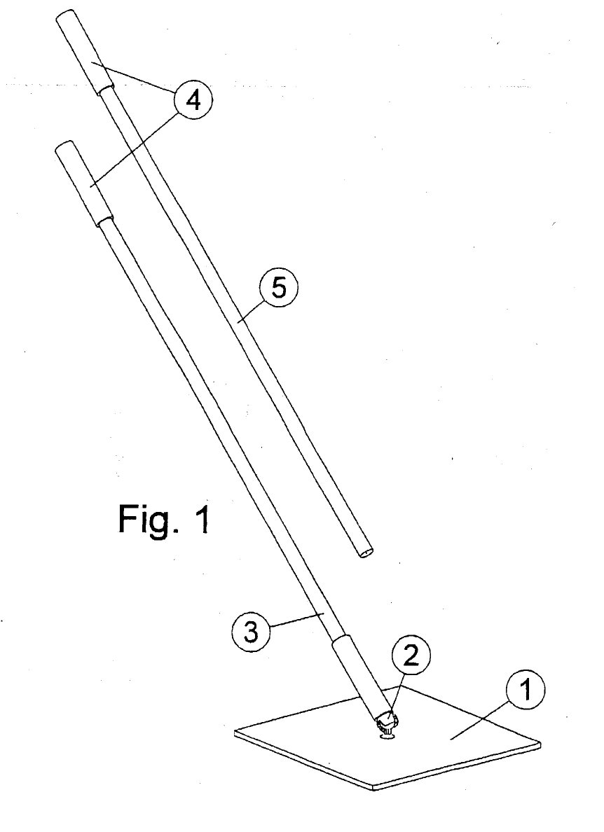

FIG. 1 shows in a perspective view a preferred embodiment of the insect extermination device;

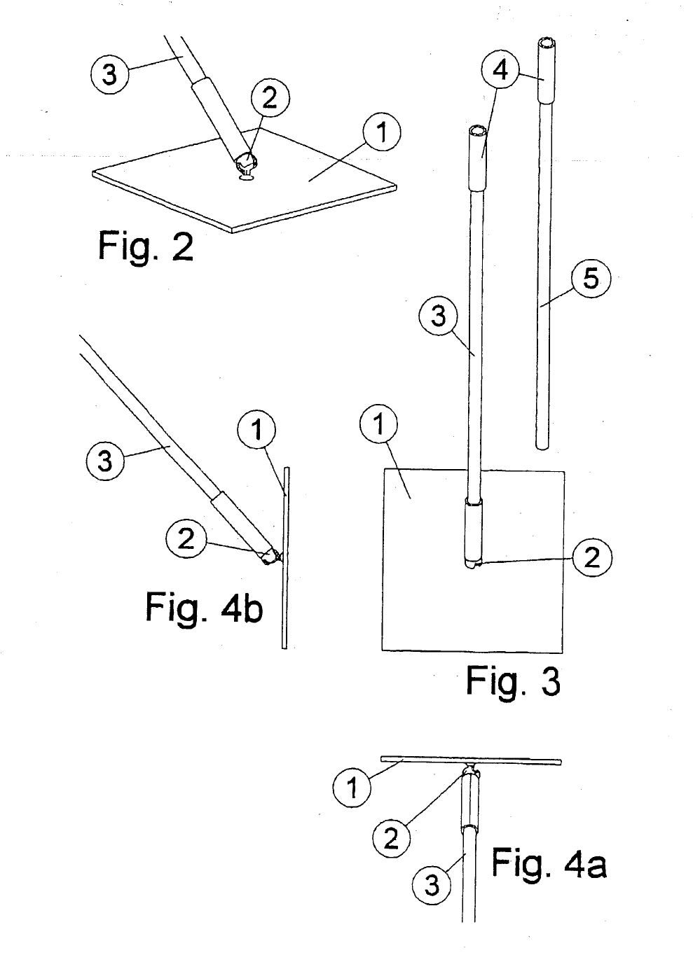

FIG. 2 shows the detail base plate of the device from FIG. 1 in a perspective view;

FIG. 3 shows the detail base plate of the device from FIG. 1 in view from above.

FIG. 4a shows the detail base plate of the device from FIG. 1 in side view; and

FIG. 4b shows the detail base plate of the device from FIG. 1 in a further side view.

In FIG. 1, an insect extermination device can be seen in the preferred plexiglass embodiment with a joint and extension pieces for expanding the handle.

The square, transparent plexiglass base plate 1 is connected with plexiglass handle 3 by means of a plexiglass joint 2. The joint 2 is formed in such a way that it can be adjusted in various angle positions with a slight use of force. This can occur in notch steps or as shown here without steps. The plexiglass handle 3 can be extended by means of the bushing 4 by using the extension piece 5, which is inserted into the bushing 4.

All parts can be taken apart so that nothing prevents transporting the device in for example a bag or suitcase.

For the purpose of better visibility and better understandability, details and various views of the device are again visible in the FIGS. 2-4b, whereby the same parts are provided with the same reference numbers.

### Reference Number List

1. Base Plate

2. Joint

3. Handle

4. Bushing

5. Handle extension

1. An insect extermination device consisting of
a base plate and
a shaft-shaped handle (3) arranged at the base plate,
whereby the longitudinal axis of the handle penetrates the plain of the base plate.

2. An insect extermination device according to claim 1, characterized in that the shaft-shaped handle is formed at the base plate or formed with this as one piece.

3. An insect extermination device according to claim 1, characterized in that the shaft-shaped handle is attached to the base plate and can be detached from it.

4. An insect extermination device according to claim 3, characterized in that the shaft-shaped handle is attached to the base plate by means of a coupling piece like a grafting or something similar.

5. An insect extermination device according to claim 4, characterized in that the coupling piece is formed as a joint (2) that is adjustable in various angles or can be locked into place.

6. An insect extermination device according to one or several of the previous claims, characterized in that the base plate has at least one corner.

7. An insect extermination device according to claim 6, characterized in that the base plate has at least one right-angled corner.

8. An insect extermination device according to claim 7, characterized in that the base plate is rectangularly formed.

9. An insect extermination device according to claim 8, characterized in that the base plate (1) is formed as a square.

10. An insect extermination device according to claim 6, characterized in that the base plate (1) is formed as a polygon.

11. An insect extermination device according to one or several of the previous claims, characterized in that the shaft-shaped handle (3) is formed so that it is prolongable.

12. An insect extermination device according to claim 11, characterized in that the shaft-shaped handle is formed so that it is prolongable by means of extension pieces (4,5).

13. An insect extermination device according to claim 11, characterized in that the shaft-shaped handle is formed so that it is prolongable like a telescope.

14. An insect extermination device according to one or several of the preceding claims, characterized in that it is formed from a material that can be washed off, is washable or can be cleaned in a dishwasher.

15. An insect extermination device according to one or several of the preceding claims, characterized in that it consists of a transparent or translucent material.

16. An insect extermination device according to claim 15, characterized in that it consists of transparent plastic like polyethylene (PE), polyethylene methacrylate (PMMA, Lucite, plexiglass), polycarbonate (PC) or something similar.

17. An insect extermination device according to one or several of the preceding claims, characterized in that it is comprised of several interchangeable base plates of various sizes and/or forms and/or materials.
